(19) United States
(12) Patent Application Publication
(10) Pub. No.: US 2008/0285566 A1
(43) Pub. Date: Nov. 20, 2008

(54) METHOD AND APPARATUS FOR PROVIDING AND UTILIZING RADIO LINK CONTROL AND MEDIUM ACCESS CONTROL PACKET DELIVERY NOTIFICATION

(75) Inventors: Mohammed Sammour, Montreal (CA); Shankar Somasundaram, Deer Park, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/110,126

(22) Filed: Apr. 25, 2008

Related U.S. Application Data
(60) Provisional application No. 60/914,402, filed on Apr. 27, 2007.

(51) Int. Cl. H04L 12/28

(52) U.S. Cl. 370/394

(57) ABSTRACT

A method and apparatus for providing and utilizing radio link control (RLC) and medium access control (MAC) packet delivery notification are disclosed. A MAC entity tracks a delivery status of a MAC protocol data unit (PDU) and sends MAC service data unit (SDU) delivery notification to an RLC entity and/or an upper layer upon occurrence of a triggering event. The triggering event may be expiration of a timer, a packet discard decision, MAC reset, MAC re-establishment, or a request from the upper layer. The RLC entity may also track a delivery status of an RLC service data unit (SDU) and send RLC delivery notification to the upper layer. An upper layer including a header compression entity may adjust a header compression parameter based on the RLC delivery notification or the MAC delivery notification. The RLC delivery notification may be used for lossless handover. Retransmission may be performed at the upper layer based on the RLC delivery notification or the MAC delivery notification.

### CROSS REFERENCE TO RELATED APPLICATIONS

This application claims the benefit of U.S. provisional application No. 60/914,402 filed Apr. 27, 2007, which is incorporated by reference as if fully set forth.

### FIELD OF INVENTION

This application is related to wireless communications.

### BACKGROUND

Hybrid automatic repeat request (HARQ)-assisted radio link control (RLC) delivery notification or confirmation services, (i.e., HARQ-assisted automatic repeat request (ARQ)), have been proposed. In HARQ-assisted RLC delivery notification or confirmation services, the medium access control (MAC) layer provides delivery notification or confirmation of an RLC protocol data unit (PDU) to the RLC ARQ entity. If the HARQ transmitter detects a failed delivery of a transport block (TB), (e.g., due to reaching a maximum retransmission limit), a relevant ARQ entity is notified of the failed delivery of an underlying RLC PDU and retransmissions and/or re-segmentation of the RLC PDU may be triggered. This service is referred to as MAC delivery notification services.

An acknowledged mode (AM) RLC entity provides RLC delivery notification or confirmation services to upper layers, such as packet data convergence protocol (PDCP) entity. The RLC delivery notification or confirmation services are based on RLC ARQ acknowledgements, (i.e., status reports). The RLC-AM-DATA-Conf primitive is used by the AM RLC entity to confirm to the upper layers the reception of an RLC service data unit (SDU) by the peer RLC AM entity or to inform the upper layers of a discarded SDU. These services are referred to as ARQ-based RLC delivery notification services.

In universal terrestrial radio access network (UTRAN), RLC transparent mode (TM), unacknowledged mode (UM), or AM can utilize a timer-based discard mechanism, (e.g., for clearing the RLC buffers after a certain time from the reception of the RLC SDU from the upper layers). Upon discarding the RLC SDU, RLC-UM-DATA-Conf is used by the UM RLC entity to inform the upper layers of the discarded RLC SDU. However, such discarding is not based on transmission status acknowledgements, but purely timer-based. In other words, RLC-UM-DATA-Conf does not convey any information on whether an RLC SDU was successfully delivered or not. Such services are referred to as RLC discard notification services.

### SUMMARY

A method and apparatus for providing and utilizing RLC and MAC packet delivery notification are disclosed. A MAC entity tracks a delivery status of a MAC PDU and sends MAC service data unit (SDU) delivery notification to an RLC entity and/or an upper layer upon occurrence of a triggering event. The triggering event may be expiration of a timer, a packet discard decision, MAC reset, MAC re-establishment, or a request from the upper layer. The RLC entity may also track a delivery status of an RLC SDU and send RLC delivery notification to the upper layer. An upper layer including a header compression entity may adjust a header compression parameter based on the RLC delivery notification or the MAC delivery notification. The RLC delivery notification may be used for lossless handover. Retransmission may be performed at the upper layer based on the RLC delivery notification or the MAC delivery notification.

### BRIEF DESCRIPTION OF THE DRAWINGS

A more detailed understanding may be had from the following description, given by way of example in conjunction with the accompanying drawings wherein:

FIG. 1 shows an example wireless transmit/receive unit (WTRU) and network; and

FIG. 2 shows three HARQ PDU or RLC SDU delivery statuses.

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “Node B” includes but is not limited to a base station, a site controller, an access point (AP), or any other type of interfacing device capable of operating in a wireless environment.

Hereinafter, the terminology “state” and “status” and “notification” and “confirmation” will be used interchangeably, respectively.

Embodiments disclosed herein are applicable to any wireless communication systems, such as third generation partnership project (3GPP) universal mobile telecommunication system (UMTS), long term evolution (LTE), high speed packet access enhancements (HSPA+), etc., and their constituent apparatus, such as WTRUs and Node Bs, etc.

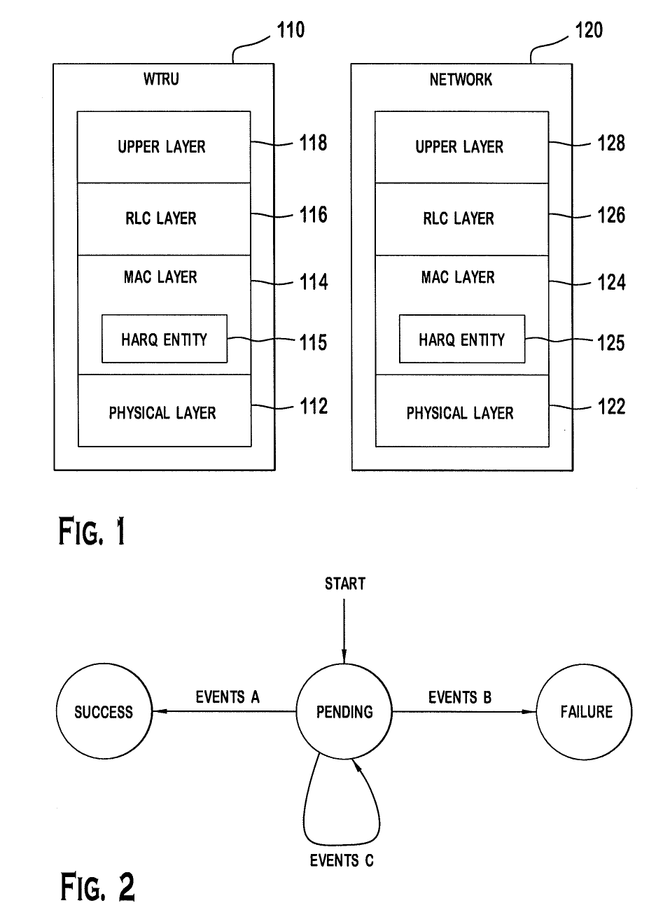

FIG. 1 shows an example WTRU 110 and network 120. The WTRU 110 and the network 120 include a physical layer 112, 122, a MAC layer 114, 124, an RLC layer 116, 126, and upper layers 118, 128, respectively. The upper layers 118, 128 may be a PDCP layer, a radio resource control (RRC) layer, a non-access stratum (NAS) layer, etc. The MAC layer 114, 124, includes a HARQ entity 115, 125. In the network side, all or a part of the MAC layer 124 and the RLC layer 126 may be included in a Node-B or other network entities.

The HARQ entity 115, 125 implement a HARQ transmission and retransmission mechanism based on HARQ feedback for delivery of a HARQ PDU. The MAC layer 114, 124 (or the HARQ entity 115, 125 in the MAC layer 114, 124) is configured to provide a MAC delivery notification services to indicate the delivery status of a MAC SDU or a MAC PDU to the RLC layer 116, 126 or the higher layers 118, 128.

The MAC layer 114, 124 tracks a delivery status of a MAC PDU. Each HARQ PDU may be in one of three (3) HARQ PDU delivery statuses: pending, success, or failure as shown in FIG. 2. Alternatively, the pending and failure states may be merged into one state and the HARQ PDU delivery status may be one of two states, (e.g., “not delivered” state and “successfully delivered” state). The pending state is an intermediate state, while the success or failure states are final states for the HARQ PDU. Transition between these three states is based on the occurrence of one or more events, which are classified into three (3) event groups (A, B, or C).

The status of a HARQ PDU begins from the pending state, while the HARQ PDU is in the process of being transmitted or retransmitted by the HARQ entity 115, 125, and final status (success or failure) is yet to be determined.

Upon occurrence of an event A, the HARQ PDU delivery status changes from pending to success. The event A includes, but is not limited to, the following events:
(1) Reception of HARQ positive acknowledgement (ACK); and
(2) Reception of HARQ ACK and elapse of a safety time with no error message arriving. The safety time may be used to allow for the potential arrival of error messages, (e.g., notification of problems related to a HARQ negative acknowledgement (NACK)-to-ACK error).

Upon occurrence of an event B, the HARQ PDU delivery status changes from pending to failure. Event B includes, but is not limited to, the following events:
(1) Reception of HARQ NACK and reaching the maximum number of HARQ retransmission attempts;
(2) Timer expiry, (e.g., if delivery of the HARQ PDU is not successful after a certain time, packet delivery is declared a failure);
(3) A decision to discard a packet (PDU or SDU), (e.g. upon timer expiry, or upon a reset or re-establishment of the MAC entity); and
(4) A decision to preempt the transmission of a packet (PDU or SDU).

Upon occurrence of an event C, the HARQ PDU delivery status remains as pending. Event C may be reception of HARQ NACK, and not reaching the maximum number of HARQ retransmission attempts.

Multiple HARQ SDUs may be included in one HARQ PDU, (i.e., multiple HARQ SDUs may be multiplexed or concatenated into one HARQ PDU). The MAC SDU, (i.e., RLC PDU), inherits the status, (i.e., success, failure, or pending), of the underlying HARQ PDU. For example, if HARQ PDU status becomes successful, then all of the MAC SDUs, (i.e., RLC PDUs), contained in the HARQ PDU will have a successful delivery status.

The MAC layer 114, 124 sends MAC delivery notification to the RLC layer 116, 126 or upper layers 118. 128, (such as PDCP layer, radio resource control (RRC) layer, non-access stratum (NAS) layer, etc.). The MAC delivery notification may be triggered by certain events including, but not limited to, the following events:
(1) Reaching a final state, (i.e., success or failure): Once the final state of a MAC SDU, (e.g., RLC PDU), is determined, the MAC layer 114, 124 informs the RLC layer 116, 126 (or upper layers 118, 128) of the status of the MAC SDU or RLC PDU;
(2) Reaching a specific final state, (i.e., either success or failure): For example, the upper layer 118, 128 may want to be informed only if a particular state is reached, (e.g., when the failure state is reached, but not when the success state is reached; or vice versa). Once such particular final state for a MAC SDU or MAC PDU is determined, the MAC layer 114, 124 informs the RLC layer 116, 126 (or upper layer 118, 128) of the status of the MAC SDU or RLC PDU;
(3) Timer expiry: After a certain time, the MAC layer 114, 124 informs the RLC layer 116, 126 (or upper layer 118, 128) of the status of a MAC SDU or RLC PDU;
(4) Discard decision: If discarding of a MAC PDU or MAC SDU occurs at the MAC layer 114, 124, (e.g., due to reset or re-establishment of the MAC, or any other reason), the MAC layer 114, 124 informs the RLC layer 116, 126 (or upper layer 118, 128) of the status of a MAC SDU included in the discarded MAC PDU;
(5) Reset or re-establishment of the MAC layer: If MAC layer or MAC entity is reset or re-established, the MAC layer 114, 124 informs the RLC layer 116, 126 (or upper layer 118, 128) of the status of MAC SDU(s) it is handling; and
(6) Request from upper-layer: the RLC layer 116, 126 (or other upper layer 118, 128) may explicitly poll the MAC layer 114, 124 to provide the status of a MAC SDU.

The RLC layer 116, 126 or upper layer 118, 128 may or may not wish to be notified of the MAC SDU delivery status. It may be indicated to the MAC layer 114, 124 through a primitive that the RLC layer uses to request transmission of a MAC SDU. Alternatively, a configuration parameter may be used to activate or de-activate notification for a certain logical channel.

Besides the MAC delivery notification, the RLC layer 116, 126 may also provide RLC delivery notification services to upper layer 118, 128, (such as PDCP layer, RRC layer, NAS layer, etc.). The RLC entity 116, 126 may be a TM RLC entity, a UM RLC entity, or an AM RLC entity. The RLC entity 116, 126 may make the RLC delivery notification based on the MAC delivery notification from the MAC layer 114, 124, (i.e., HARQ-assisted RLC delivery notification), and/or based on ARQ mechanism at the RLC layer 116, 126, (i.e., ARQ-based RLC delivery notification).

An RLC SDU may be in one of three (3) delivery states with respect to its delivery status: pending, success, or failure, as shown in FIG. 2. Alternatively, the pending and failure states may be merged into one state and the RLC SDU delivery status may be one of two states, (e.g., “not delivered” state and “successfully delivered” state). The pending state is an intermediate state, while the success or failure states are final states for an RLC SDU. Transition between the states is based on the occurrence of one or more events, which are classified into three event groups (A, B, or C).

The state of an RLC SDU begins in the pending state. Upon occurrence of an event A, the RLC SDU delivery status changes from pending to success. Event A includes, but is not limited to, the following events:
(1) Indication or reception of MAC/HARQ successful delivery notification on an RLC PDU that contains the RLC SDU when the RLC SDU is not segmented, (i.e., standalone or concatenated); and
(2) Indication or reception of MAC/HARQ successful delivery notification on all RLC PDUs that constitute a part of the RLC SDU, (i.e., RLC segment or RLC sub-segment), when the RLC SDU is segmented.

Upon occurrence of an event B, the RLC SDU delivery status changes from pending to failure. Event B includes, but is not limited to, the following events:
(1) Indication or reception of MAC/HARQ failed delivery notification on an RLC PDU, (i.e., MAC SDU), that contains the RLC SDU when the RLC SDU is not segmented;
(2) Indication or reception of MAC/HARQ failed delivery notification on any RLC PDU, (i.e., RLC segment or RLC sub-segment), that constitutes a part of the RLC SDU when the RLC SDU is segmented;
(3) Timer expiry, (e.g., after a certain time, if the RLC SDU is not successfully delivered, packet delivery will be declared a failure);
(4) A decision to discard the RLC PDU or SDU, (e.g., due to reset or re-establishment of the RLC, or any other reason);
(5) Reset or re-establishment of the RLC layer; and
(6) A decision to pre-empt the transmission of the RLC PDU or SDU.

Upon occurrence of an event C, the RLC SDU delivery status remains as pending. Event C includes, but is not limited to, the following events:
(1) Indication or reception of MAC/HARQ pending delivery notification on the RLC PDU that contains the RLC SDU when the RLC SDU is not segmented; and
(2) Indication or reception of MAC/HARQ pending delivery notification on any RLC PDU, (i.e., RLC segment or RLC sub-segment), that constitutes a part of the RLC SDU when the RLC SDU is segmented.

Alternatively, the RLC entity 116, 126 may make the RLC delivery notification based on RLC level ARQ feedback from the peer RLC entity. The RLC ARQ mechanism provides retransmission service on an RLC PDU level. RLC ARQ status reports are sent by the receiver to the transmitter to indicate the delivery status of RLC PDUs, (i.e., ARQ ACK/NACK). The RLC entity 116, 126 may send RLC delivery notification to higher layers 118, 128, (such as RRC layer, PDCP layer, NAS layer, or the like), based on the ARQ mechanism only, based on MAC/HARQ delivery notification only, or based on both.

Referring again to FIG. 2, an RLC SDU may be in one of three states with respect to its delivery status: pending, success, or failure. The status of the RLC SDU begins in the pending state and changes upon occurrence of certain events, events A, B, or C.

Upon occurrence of an event A, an RLC SDU delivery status changes from pending to success. Event A includes, but is not limited to, the following events:
(1) Indication or reception of MAC successful delivery notification on an RLC PDU that contains the RLC SDU when the RLC SDU is not segmented, (i.e., standalone or concatenated);
(2) Indication or reception of an ARQ-based successful delivery confirmation from the peer RLC entity on an RLC PDU that contains the RLC SDU when the RLC SDU is not segmented;
(3) Indication or reception of MAC successful delivery notification on all RLC PDUs, (i.e., RLC segments or RLC sub-segments), that constitute a part of the RLC SDU when the RLC SDU is segmented; and
(4) Indication or reception of ARQ-based successful delivery confirmation from the peer RLC entity on all RLC PDUs, (i.e., RLC segments or RLC sub-segments), that constitute a part of the RLC SDU when the RLC SDU is segmented.

Upon occurrence of an event B, the RLC SDU delivery status changes from pending to failure. Event B includes, but is not limited to, the following events:
(1) Indication or reception of MAC failed delivery confirmation on an RLC PDU that contains the RLC SDU, and reaching the maximum number of ARQ retransmission attempts when the RLC SDU is not segmented, (i.e., standalone or concatenated);
(2) Indication or reception of MAC failed delivery confirmations on any RLC PDU, (i.e., RLC segment or RLC sub-segment), that constitutes a part of the RLC SDU, and reaching the maximum number of ARQ retransmission attempts when the RLC SDU is segmented;
(3) Timer expiry, (e.g., after a certain time, if not successful, packet (i.e., SDU or PDU), delivery will be declared a failure);
(4) A decision to discard the packet, (i.e., SDU or PDU), (e.g., due to reset or re-establishment of the RLC, or any other reason);
(5) Reset or re-establishment of the RLC layer; and
(6) A decision to pre-empt the transmission of the packet, (i.e., SDU or PDU)

Upon occurrence of an event C, the RLC SDU delivery status remains as pending. Event C includes, but is not limited to, the following events:
(1) Indication or reception of a MAC pending delivery confirmation on the RLC PDU that contains the RLC SDU when the RLC SDU is not segmented, (i.e., stand alone or concatenated); and
(2) Indication or reception of MAC pending delivery confirmations on any RLC PDU, (i.e., RLC segment or RLC sub-segment), that constitutes a part of the RLC SDU when the RLC SDU is segmented.

The RLC delivery notification to the upper layers 118, 128, (e.g., PDCP, RRC, NAS, etc.), for an RLC SDU, (e.g., PDCP PDU, RRC PDU, or the like), may be triggered upon certain events. The triggering events include, but are not limited to, the following events:
(1) Reaching a final state, (i.e., success or failure): Once the final state is determined for an RLC SDU, the RLC entity 116, 126 informs the upper layer 118, 128, (e.g., PDCP, RRC, NAS, etc.), of the status of an RLC SDU;
(2) Reaching a specific final state, (i.e., either success or failure): For example, the upper layer 118, 128 may want to be informed only if a particular state is reached, (e.g., when the failure state is reached but not when the success state is reached, or vice versa). Once such particular final state is determined for an RLC SDU, the RLC entity 116, 126 informs the upper layer 118, 128, (e.g., PDCP, RRC, NAS, etc.), of the status of an RLC SDU;
(3) Timer expiry: After a certain time, the RLC entity 116, 126 may inform the upper layer 118, 128 of the status of an RLC SDU;
(4) Discard decision: If discarding occurs, the RLC entity 116, 126 may inform the upper layer 118, 128 of the status of an RLC SDU, (e.g., due to reset or re-establishment of the RLC, or any other reason);
(5) Reset or re-establishment of the RLC layer; and
(6) Request from the upper layer 118, 128: The upper layer 118, 128 may explicitly poll the RLC entity 116, 126 inquiring about the status of an RLC SDU.

The upper layer 118, 128, (e.g., PDCP, RRC or NAS), may or may not wish to be notified of the packet delivery status. A primitive that the upper layer uses to request transmission of an RLC SDU may or may not request a notification or confirmation from the RLC entity 116, 126. Alternatively, a configuration parameter may be used to activate or de-activate notification for a certain radio bearer.

Furthermore, the primitive that the upper layer 118, 128 uses to request transmission of an RLC SDU, (e.g., RLC-AM-DATA-Req), may indicate whether delivery notification should be based on the ARQ-based mechanism only, the MAC/HARQ delivery notification mechanism only, or both. The primitive used to confirm to the upper layer 118,128, (e.g., RLC-AM-DATA-Conf), may contain multiple status fields to indicate the delivery status based on MAC/HARQ delivery notification and the delivery status that is ARQ-based. Alternatively, if desired, a single status field based on either one only, or combining the results from both mechanisms may be utilized.

In accordance with another embodiment, adaptive header compression, (e.g., robust header compression (ROHC)), may take into account the RLC delivery notification provided by the RLC entity 116, 126, (e.g., HARQ-assisted RLC delivery notification or ARQ-based RLC delivery notification services), or the MAC delivery notification directly provided by the MAC entity 114, 124.

An ROHC compressor may adapt its compression behavior based on the RLC delivery notification services or the MAC delivery notification. For example, when the ROHC compressor (located in a WTRU or a Node B) is notified of one or more RLC SDU error(s), (e.g., potentially after a given threshold), the ROHC compressor may adapt its behavior and produce more robust header, (e.g., via moving into a lower compression state such as Initialization and Refresh (IR) or First Order (FO) states). On the other hand, when the ROHC compressor is notified of one or more RLC SDU delivery success, (e.g., potentially after a given threshold), the ROHC compressor may adapt its behavior and produce more efficient header, (e.g., via moving into a higher compression state such as Second Order (SO) or FO states).

The ROHC compressor may request an RLC or MAC delivery notification for packets that are deemed important, (such as context initialization or update packets), in order to conduct fast retransmission of such packets in case of delivery failure. A decompressor at the receiver side may also be able to make use of MAC or RLC delivery notification information.

Lossless handover has been considered for services that require reliability, (e.g., transmission control protocol (TCP)), and typically make use of RLC AM. In accordance with another embodiment, data forwarding from a source Node B to a target Node B for lossless handover for RLC UM or TM services may be facilitated using HARQ-assisted RLC delivery notification services. For example, during handover, the source Node B may utilize the HARQ-assisted RLC SDU delivery status information to forward all packets that are still stored in the source Node B, (e.g., in the PDCP layer), and that do not have successful delivery status according to the HARQ-assisted RLC delivery notification service. This is useful for performing data forwarding for applications such as voice over IP (VoIP) or video for example.

During handover, a WTRU may start sending data on a given HARQ process, but due to the need to handover immediately to the target cell, the WTRU may not be able to continue sending or resending the HARQ PDU in the target cell. In accordance with the conventional standards, HARQ and RLC resets are required when a WTRU moves to the target Node B. For RLC AM services, the ARQ mechanism may cover the potential data loss in this case since ARQ may provide reliable retransmission. However, RLC UM or TM services may experience some loss due to the RLC and HARQ reset. In order to prevent such loss during the handover for RLC UM or TM (or even AM) services, (e.g., VoIP or video over IP), the HARQ-level transmission in the target Node B may be reinitialized.

Packets that were not delivered in the source cell are not discarded at MAC or HARQ reset or re-establishment due to handover, but maintained, and their HARQ transmissions are restarted in the target cell. For example, upon detecting a handover event, the WTRU may re-start the HARQ transmission in the target cell for the same packet that the WTRU was transmitting or re-transmitting in the source cell, and also potentially reset the number of HARQ retransmissions that have occurred in the source cell. In prior art, UM or TM services cannot be retransmitted upon a MAC/RLC reset due to handover, and the MAC SDUs or RLC SDUs would be lost. In order to prevent such loss during handover, the MAC SDUs may be retransmitted via restarting HARQ retransmissions in the target cell.

Alternatively, PDCP-level retransmission may be performed. The PDCP layer may utilize the RLC delivery notification services, (i.e., HARQ-assisted and/or ARQ-based), and/or its knowledge of handover event in order to conduct PDCP-level retransmission for those packets that are in the PDCP buffer and whose delivery status became failure during the handover procedure.

Any higher level application may make use of the packet delivery notification/confirmation mechanisms disclosed herein, (i.e., the HARQ-assisted RLC delivery notification services, ARQ-based RLC delivery notification services, and/or MAC delivery notification services). For example, transport layer protocols such as user datagram protocol (UDP), real time transmit protocol (RTP), real time transmission control protocol (RTCP), TCP, IP, or the like may utilize the HARQ-assisted or ARQ-based RLC SDU delivery notification services to trigger a specific action, (e.g., retransmission), or to adapt their behavior, (e.g., flow control).

Voice, (e.g., VoIP), or video application may make use of the delivery notification services in a multitude of ways. For example, VoIP applications or any other applications dependent on protocols like RTP and RTCP and using RLC UM or TM may make use of the RLC packet delivery notifications to control delay or jitter effects.

The RLC delivery notification services, (i.e., HARQ-assisted or ARQ-based), may also be used to optimize RLC functions, such as its window-based flow control mechanism. The transmit window may be adjusted based on HARQ-assisted RLC packet delivery information. For example, the window size may be adjusted upon receipt of HARQ-assisted error notification for faster recovery from the situation where the link condition is very bad. The same may be applied for optimizing other L2/L3 or even L1 functions.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for packet delivery notification, the method comprising:
a medium access control (MAC) entity tracking a delivery status of a MAC service data unit (SDU); and
the MAC entity sending MAC SDU delivery notification to at least one of a radio link control (RLC) entity and an upper layer upon occurrence of a triggering event, wherein the triggering event is at least one of expiration of a timer, a packet discard decision, MAC reset, MAC re-establishment, and a request from the upper layer.

2. The method of claim 1 wherein the delivery status of the MAC SDU is at least one of not-delivered and successfully delivered.

3. The method of claim 1 wherein the delivery status of the MAC SDU is at least one of pending, success, and failure.

4. The method of claim 3 wherein the status of the MAC SDU transitions from pending to success upon reception of hybrid automatic repeat request (HARQ) positive acknowledgement (ACK) and elapse of a safety time with no error message arriving.

5. The method of claim 3 wherein the status of the MAC SDU transitions from pending to failure upon expiration of a timer.

6. The method of claim 3 wherein the status of the MAC SDU transitions from pending to failure upon a decision to discard at least one of the MAC SDU and a MAC PDU containing the MAC SDU.

7. The method of claim 3 wherein the status of the MAC SDU transitions from pending to failure upon resetting or re-establishing the MAC entity.

8. The method of claim 3 wherein the status of the MAC SDU transitions from pending to failure upon a decision to preempt transmission of at least one of the MAC SDU and a MAC PDU containing the MAC SDU.

9. The method of claim 1 wherein the upper layer is at least one of a packet data convergence protocol (PDCP) layer, a radio resource control (RRC) layer, a non-access stratum (NAS) layer.

10. The method of claim 1 further comprising:
the RLC entity tracking a delivery status of an RLC service data unit (SDU); and
the RLC entity sending RLC delivery notification to the upper layer.

11. The method of claim 10 wherein the delivery status of the RLC SDU is at least one of not-delivered and successfully delivered.

12. The method of claim 10 wherein the delivery status of the RLC SDU is at least one of pending, success, and failure.

13. The method of claim 12 wherein the delivery status of the RLC SDU transitions from pending to failure upon expiration of a timer.

14. The method of claim 12 wherein the delivery status of the RLC SDU transitions from pending to failure upon a decision to discard at least one of the RLC SDU and a RLC PDU containing the RLC SDU.

15. The method of claim 12 wherein the delivery status of the RLC SDU transitions from pending to failure upon resetting or re-establishing the RLC entity.

16. The method of claim 12 wherein the delivery status of the RLC SDU transitions from pending to failure upon a decision to preempt transmission of one of the RLC SDU and a RLC PDU containing the RLC SDU.

17. The method of claim 12 wherein the delivery status of the RLC SDU remains as pending upon reception of MAC delivery notification indicating a pending status of a MAC SDU containing the RLC SDU.

18. The method of claim 12 wherein the RLC entity makes the RLC delivery notification based on at least one of the MAC delivery notification from the MAC entity and RLC automatic repeat request (ARQ) mechanism.

19. A method for utilizing packet delivery notification, the method comprising:
tracking a delivery status of at least one of a radio link control (RLC) service data unit (SDU) and a medium access control (MAC) service data unit (SDU) that carries at least a part of the RLC SDU;
sending at least one of RLC delivery notification and MAC delivery notification to an upper layer including a header compression entity; and
adjusting a header compression parameter based on at least one of the RLC delivery notification and the MAC delivery notification.

20. The method of claim 19 wherein the RLC delivery notification is hybrid automatic repeat request (HARQ)-assisted RLC delivery notification.

21. The method of claim 19 wherein the RLC delivery notification is automatic repeat request (ARQ)-based RLC delivery notification.

22. The method of claim 19 further comprising:
the header compression entity requesting at least one of the RLC delivery notification and the MAC delivery notification for a packet that is deemed important.

23. A method for utilizing packet delivery notification during handover, the method comprising:
generating a medium access control (MAC) delivery notification based on hybrid automatic repeat request (HARQ) feedback information available at a medium access control (MAC) entity; and
initiating, at a target cell, HARQ transmissions of a packet that was not successfully transmitted in a source cell based on the MAC delivery notification.

24. The method of claim 23 further comprising:
resetting a number of HARQ retransmissions that have occurred in the source cell.

25. The method of claim 23 wherein the packet is one of RLC unacknowledged mode (UM) data and RLC transparent mode (TM) data.

26. A method for utilizing packet delivery notification, the method comprising:
generating a radio link control (RLC) delivery notification based on at least one of a medium access control (MAC) delivery notification from a MAC entity and RLC automatic repeat request (ARQ) mechanism;
sending the RLC delivery notification to an upper layer; and
retransmitting an RLC SDU at the upper layer based on the RLC delivery notification.

27. The method of claim 26 wherein the upper layer is one of packet data convergence protocol (PDCP) layer, radio resource control (RRC) layer, non-access stratum (NAS) layer, user datagram protocol (UDP) layer, real time transmit protocol (RTP) layer, real time transmission control protocol (RTCP) layer, transmission control protocol (TCP) layer, and Internet protocol (IP) layer.

28. The method of claim 26 further comprising:
adjusting an RLC parameter based on the RLC delivery notification.

29. An apparatus for packet delivery notification, the apparatus comprising:
an upper layer;
a radio link control (RLC) entity; and
a medium access control (MAC) entity configured to track a delivery status of a MAC service data unit (SDU), and send MAC delivery notification to at least one of the RLC entity and the upper layer upon occurrence of a triggering event, wherein the triggering event is one of expiration of a timer, a packet discard decision, MAC reset, MAC re-establishment, and a request from the upper layer.

30. The apparatus of claim 29 wherein the delivery status of the MAC SDU is one of not-delivered and successfully delivered.

31. The apparatus of claim 29 wherein the delivery status of the MAC SDU is at least one of pending, success, and failure.

32. The apparatus of claim 29 wherein the status of the MAC SDU transitions from pending to success upon reception of hybrid automatic repeat request (HARQ) positive acknowledgement (ACK) and elapse of a safety time with no error message arriving.

33. The apparatus of claim 29 wherein the status of the MAC SDU transitions from pending to failure upon expiration of a timer.

34. The apparatus of claim 29 wherein the status of the MAC SDU transitions from pending to failure upon a decision to discard one of the MAC SDU and a MAC PDU containing the MAC SDU.

35. The apparatus of claim 29 wherein the status of the MAC SDU transitions from pending to failure upon resetting or re-establishing the MAC entity.

36. The apparatus of claim 29 wherein the status of the MAC SDU transitions from pending to failure upon a decision to preempt transmission of at least one of the MAC SDU and a MAC PDU containing the MAC SDU.

37. The apparatus of claim 29 wherein the upper layer is at least one of a packet data convergence protocol (PDCP) layer, a radio resource control (RRC) layer, a non-access stratum (NAS) layer.

38. The apparatus of claim 29 wherein the RLC entity is configured to track a delivery status of an RLC service data unit (SDU) and send RLC delivery notification to the upper layer.

39. The apparatus of claim 38 wherein the delivery status of the RLC SDU is one of not-delivered and successfully delivered.

40. The apparatus of claim 38 wherein the delivery status of the RLC SDU is at least one of pending, success, and failure.

41. The apparatus of claim 40 wherein the delivery status of the RLC SDU transitions from pending to failure upon expiration of a timer.

42. The apparatus of claim 40 wherein the delivery status of the RLC SDU transitions from pending to failure upon a decision to discard at least one of the RLC SDU and a RLC PDU containing the RLC SDU.

43. The apparatus of claim 40 wherein the delivery status of the RLC SDU transitions from pending to failure upon resetting or re-establishing the RLC entity.

44. The apparatus of claim 40 wherein the delivery status of the RLC SDU transitions from pending to failure upon a decision to discard at least one of the RLC SDU and a RLC PDU containing the RLC SDU.

45. The apparatus of claim 40 wherein the delivery status of the RLC SDU remains as pending upon reception of MAC delivery notification indicating a pending status of a MAC SDU containing the RLC SDU.

46. The apparatus of claim 40 wherein the RLC entity makes the RLC delivery notification based on at least one of the MAC delivery notification from the MAC entity and RLC automatic repeat request (ARQ) mechanism.

47. An apparatus for utilizing packet delivery notification, the apparatus comprising:
an upper layer including a header compression entity;
a radio link control (RLC) entity configured to track a delivery status of an RLC service data unit (SDU), and send RLC delivery notification to the upper layer; and
a medium access control (MAC) entity configured to track a delivery status of a MAC service data unit (SDU) that carries at least a part of the RLC SDU, and send MAC delivery notification to the upper layer,
wherein the upper layer adjusts a header compression parameter based on at least one of the RLC delivery notification and the MAC delivery notification.

48. The apparatus of claim 47 wherein the RLC delivery notification is hybrid automatic repeat request (HARQ)-assisted RLC delivery notification.

49. The apparatus of claim 47 wherein the RLC delivery notification is automatic repeat request (ARQ)-based RLC delivery notification.

50. The apparatus of claim 47 wherein the header compression entity is configured to request at least one of the RLC delivery notification and the MAC delivery notification for a packet that is deemed important.

51. An apparatus for utilizing packet delivery notification during handover, the apparatus comprising:
a medium access control (MAC) entity configured to generate MAC delivery notification based on hybrid automatic repeat request (HARQ) feedback information available at the MAC entity; and
a controller configured to initiate, at a target cell, HARQ transmissions of a packet that was not successfully transmitted in a source cell based on the MAC delivery notification.

52. The apparatus of claim 51 wherein the controller resets a number of HARQ retransmissions that have occurred in the source cell.

53. The apparatus of claim 51 wherein the packet is one of RLC unacknowledged mode (UM) data and RLC transparent mode (TM) data.

54. An apparatus for utilizing packet delivery notification, the apparatus comprising:
a medium access control (MAC) entity including a hybrid automatic repeat request (HARQ) entity;
a radio link control (RLC) entity configured to generate an RLC delivery notification based on at least one of HARQ feedback information received from the MAC entity and RLC automatic repeat request (ARQ) mechanism; and
an upper layer configured to retransmit an RLC SDU based on the RLC delivery notification.

55. The apparatus of claim 54 wherein the upper layer is at least one of packet data convergence protocol (PDCP) layer, radio resource control (RRC) layer, non-access stratum (NAS) layer, user datagram protocol (UDP) layer, real time transmit protocol (RTP) layer, real time transmission control protocol (RTCP) layer, transmission control protocol (TCP) layer, and Internet protocol (IP) layer.

56. The apparatus of claim 54 wherein an RLC parameter is adjusted based on the RLC delivery notification.
